(19) United States
(12) Patent Application Publication
(10) Pub. No.: US 2026/0001205 A1
(43) Pub. Date: Jan. 1, 2026

(54) POWERED FASTENER DRIVER

(71) Applicant: TECHTRONIC CORDLESS GP, Anderson, SC (US)

(72) Inventors: Scott A. Sutherland, Greenville, SC (US); Curt A. Laugh, Anderson, SC (US)

(21) Appl. No.: 19/241,156

(22) Filed: Jun. 17, 2025

Related U.S. Application Data
(60) Provisional application No. 63/664,996, filed on Jun. 27, 2024.

(51) Int. Cl. B25C 1/04

(52) U.S. Cl. CPC B25C 1/047; B25C 1/042

(57) ABSTRACT

A powered fastener driver includes a drive blade movable from a top-dead-center (TDC) position to a driven or bottom-dead-center (BDC) position for driving a fastener into a workpiece, a piston coupled to the drive blade, a drive unit for providing torque to move the drive blade, a rotary lifter configured to receive torque from the drive unit in a first rotational direction for returning the drive blade from the BDC position toward the TDC position, and a gas spring assembly having a master supply cylinder in which gas is compressed by the piston in response to being moved from the BDC position toward the TDC position, a drive cylinder having a flange against which an end of the master supply cylinder is abutted, and an end cap secured to the master supply cylinder to apply a clamping force to the flange against the end of the master supply cylinder.

### CROSS-REFERENCE TO RELATED APPLICATIONS

This application claims priority to U.S. Provisional Patent Application No. 63/664,996 filed on Jun. 27, 2024, the entire content of which is incorporated herein by reference.

### FIELD OF THE DISCLOSURE

The present disclosure relates to power tools, and more particularly to powered fastener drivers.

### BACKGROUND OF THE DISCLOSURE

Powered fastener drivers often include a gas spring assembly in which compressed gas is stored and the force imparted by the compressed gas on a piston slidably positioned in a drive cylinder translates a piston and drive blade coupled to the piston from a top-dead-center (TDC) position to a bottom-dead-center (BDC) position. Interfaces between the drive cylinder, master supply cylinder, and other components are often sealed to limit leakage of the compressed gas from the gas spring assembly.

### SUMMARY OF THE DISCLOSURE

The present disclosure provides, in one aspect, a powered fastener driver including a drive blade coupled to a piston for movement therewith from a TDC position to a driven or BDC position for driving a fastener into a workpiece, a drive unit for providing torque in a first rotational direction to a rotary lifter engageable with the drive blade for moving or returning the drive blade to the TDC position, and a gas spring assembly. The gas spring assembly includes a master supply cylinder in which gas is stored and compressed by the piston in response to the piston being moved from the BDC toward the TDC position, a drive cylinder at least partially positioned within the master supply cylinder and having a flange against which an end of the master supply cylinder is abutted, and an end cap secured to the master supply cylinder to apply a clamping force to the flange against the end of the master supply cylinder, thereby axially affixing the drive cylinder to the master supply cylinder.

The present disclosure provides, in another aspect, a powered fastener driver including a drive blade coupled to a piston for movement therewith from a TDC position to a driven or BDC position for driving a fastener into a workpiece, a drive unit for providing torque in a first rotational direction to a rotary lifter engageable with the drive blade for moving or returning the drive blade to the TDC position, and a gas spring assembly. The gas spring assembly includes a master supply cylinder in which gas is stored and compressed by the piston in response to movement of the piston from the BDC toward the TDC position, a drive cylinder at least partially positioned within the master supply cylinder and having a flange against which an inner shoulder of the master supply cylinder is abutted, and an end cap secured to an end of the master supply cylinder opposite the inner shoulder to apply a clamping force to the flange against the inner shoulder thereby axially affixing the drive cylinder to the master supply cylinder.

The present disclosure provides, in another aspect, a powered fastener driver including a drive blade coupled to a piston for movement therewith from a TDC position to a driven or BDC position for driving a fastener into a workpiece, a drive unit for providing torque in a first rotational direction to a rotary lifter supported in a lifter housing, the rotary lifter engageable with the drive blade for moving or returning the drive blade to the TDC position, and a gas spring assembly. The gas spring assembly includes a master supply cylinder in which gas is stored and compressed in response to movement of the piston from the BDC position to the TDC position, a drive cylinder having an outer surface proximate a first end from which a flange extends, and an end cap. The master supply cylinder includes an inner shoulder and bosses that are fastened to the lifter housing. The drive cylinder is at least partially positioned within the master supply cylinder with the flange abutted against the inner shoulder of the master supply cylinder. The end cap is threaded to an end of the master supply cylinder opposite the inner shoulder to apply a clamping force to an opposite second end of the drive cylinder to abut the flange against the inner shoulder, thereby axially affixing the drive cylinder to the master supply cylinder.

The present disclosure provides, in another aspect, a powered fastener driver including a drive blade coupled to a piston for movement therewith from a TDC position to a driven or BDC position for driving a fastener into a workpiece, a drive unit for providing torque in a first rotational direction to a rotary lifter supported in a lifter housing, the rotary lifter engageable with the drive blade for moving or returning the drive blade to the TDC position, and a gas spring assembly. The gas spring assembly includes a master supply cylinder in which gas is stored and compressed by the piston in response to the piston being moved from the BDC position toward the TDC position and a drive cylinder including internal threads in an inner surface thereof and external threads on an outer surface thereof. The master supply cylinder has internal threads. The drive cylinder has a reference plane perpendicular to a longitudinal axis of the drive cylinder passes through the internal threads and the external threads on the drive cylinder. The internal threads of the drive cylinder are engaged with the external threads of the cylinder mount. The external threads of the drive cylinder are engaged with the internal threads of the master supply cylinder.

Other features and aspects of the invention will become apparent by consideration of the following detailed description and accompanying drawings.

### BRIEF DESCRIPTION OF THE DRAWINGS

FIG. 1 is a side view of a powered fastener driver.

FIG. 2 is a side view of the powered fastener driver of FIG. 1 with portions removed, illustrating a gas spring assembly.

FIG. 3 is a cross-sectional view of the gas spring assembly of FIG. 2.

FIG. 4 is an enlarged view of the gas spring assembly of FIG. 3.

FIG. 5 is a side view of another embodiment of a powered fastener driver with portions removed, illustrating a gas spring assembly.

FIG. 6 is a cross-sectional view of the gas spring assembly of FIG. 5.

FIG. 7 is a partial cutaway view of the gas spring assembly of FIG. 5, illustrating a drive cylinder.

FIG. 8 is a perspective view of the gas spring assembly of FIG. 5, illustrating a fill valve.

FIG. 9 is a cross-sectional view of the gas spring assembly of FIG. 6, illustrating the fill valve.

FIG. 10 is perspective view of the gas spring assembly of FIG. 5, illustrating a master supply cylinder and the drive cylinder.

FIG. 11 is a side view of another embodiment of a powered fastener driver with portions removed, illustrating a gas spring assembly.

FIG. 12 is a cross-sectional view of the gas spring assembly of FIG. 11.

FIG. 13 is an enlarged view of the gas spring assembly of FIG. 12.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

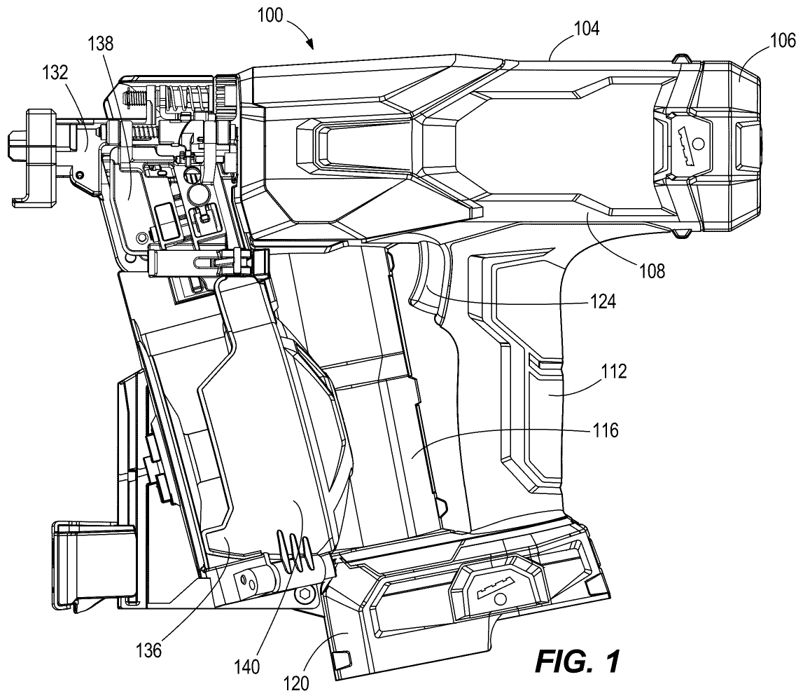

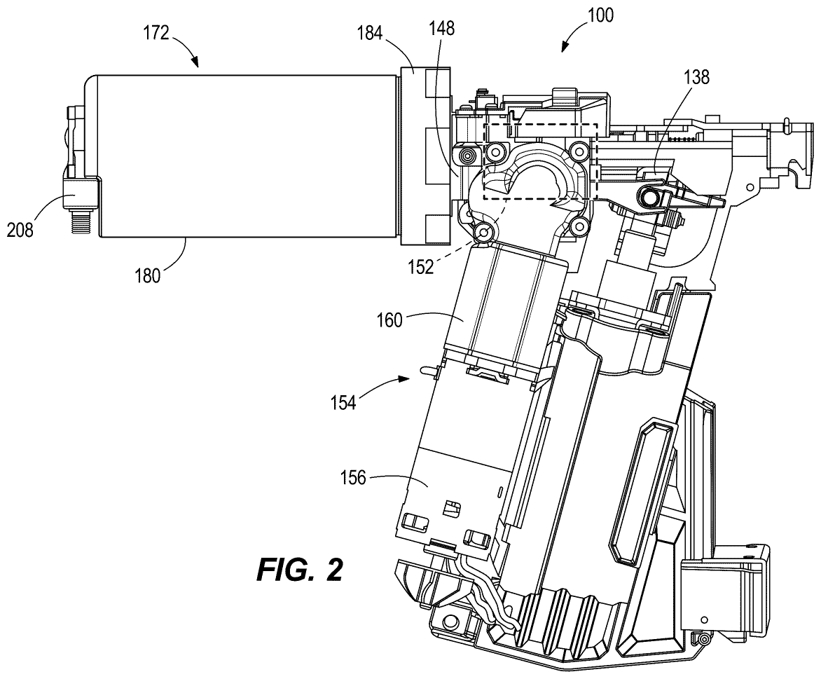

FIGS. 1-2 illustrate a gas spring-powered fastener driver 100 having a housing 104 formed with first and second housing shells and an overmolding 106. The housing 104 includes a head portion 108, a handle portion 112 extending from the head portion 108, and a drive unit housing portion 116 also extending from the head portion 108. The housing 104 also includes a battery receptacle portion 120 that extends from the handle portion 112 that is sized and shaped to receive a removable battery pack (not shown), such as an 18 Volt battery pack. In other embodiments, the battery receptacle portion 120 may be sized and shaped to receive a battery pack having another voltage. The handle portion 112 supports a trigger 124 adjacent the head portion 108 that extends outwardly and is engageable by a user to operate the fastener driver 100 (e.g., to drive a fastener into a workpiece).

The fastener driver 100 further includes a nosepiece 132 extending from the head portion 108 of the housing 104 and a magazine assembly 136 sized and shaped to receive coiled fasteners therein. The magazine assembly 136 includes a magazine cover 140 that opens to provide access to the interior of the magazine assembly 136 and the coiled fasteners therein. Individual fasteners are sequentially loaded from the magazine assembly 136 to the nosepiece 132 via a fastener delivery mechanism 138 located between the nosepiece 132 and the magazine assembly 136 during operation of the fastener driver 100. In other embodiments, the magazine may be a strip of collated nails that is not coiled.

With reference to FIG. 2, the fastener driver 100 includes a lifter housing 148 in which a lifter assembly, including a rotary lifter 152, is disposed. The fastener driver 100 also includes a drive unit 154 positioned within the drive unit housing portion 116 of the housing 104. The drive unit 154 includes an electric motor 156 and a transmission 160 (e.g., a multi-stage planetary transmission) positioned between the motor 156 and the rotary lifter 152. During a fastener driving operation, the motor 156 provides torque to the transmission 160 which, in turn, drives the rotary lifter 152 as will be described in more detail below. The rotary lifter 152, drive unit 154, and the fastener delivery mechanism 138, and operation thereof, may be identical to the lifter assembly, drive unit, and fastener delivery mechanism described in U.S. patent application Ser. No. 18/495,957 filed on Oct. 27, 2023, the entire content of which is incorporated herein by reference.

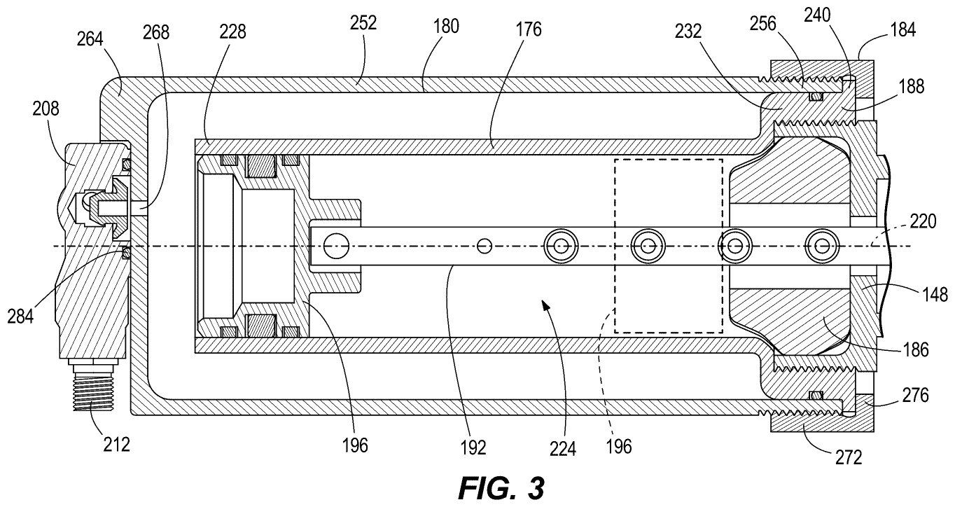

FIGS. 2-4 illustrate a first embodiment of a gas spring assembly 172 coupled to the lifter housing 148. The gas spring assembly 172 includes a drive cylinder 176, a master supply cylinder 180 in which the drive cylinder 176 is at least partially positioned, and an end cap 184 (e.g., a threaded nut) securing the drive cylinder 176 to the master supply cylinder 180. The gas spring assembly 172 also includes a bumper 186 supported at a first end 188 of the drive cylinder 176, a drive blade 192, and a piston 196 that is reciprocally slidable within the drive cylinder 176 between a top-dead-center (TDC) position (FIG. 3) and a bottom-dead-center (BDC) position (illustrated schematically in FIG. 3) adjacent the bumper 186. The drive blade 192 and piston 196 are unitized (e.g., by a pin, press-fit arrangement, etc.) to move together between the TDC and BDC positions. The rotary lifter 152 translates the drive blade 192 and the piston 196 from the BDC position toward the TDC position, thereby compressing compressed gas stored in the master supply cylinder 180. When the trigger 124 is depressed to drive a fastener into a workpiece, the rotary lifter 152 disengages the drive blade 192, permitting the compressed gas in the master supply cylinder 180 to expand and drive the piston 196 and the drive blade 192 toward the BDC position to discharge a fastener from the nosepiece 132.

With reference to FIG. 3, a fill valve assembly 208 is coupled to the master supply cylinder 180. The fill valve assembly 208 may include a Schrader valve, a Presta valve, a Dunlop valve, or some other similar valve. The fill valve assembly 208 may be accessible through a removable panel in the housing 104, for example in the overmolding 106, to expose the fill valve assembly 208. When a source of compressed gas is coupled to an inlet fitting 212 of the fill valve assembly 208, the fill valve assembly 208 opens to supply compressed gas or to the master supply cylinder 180.

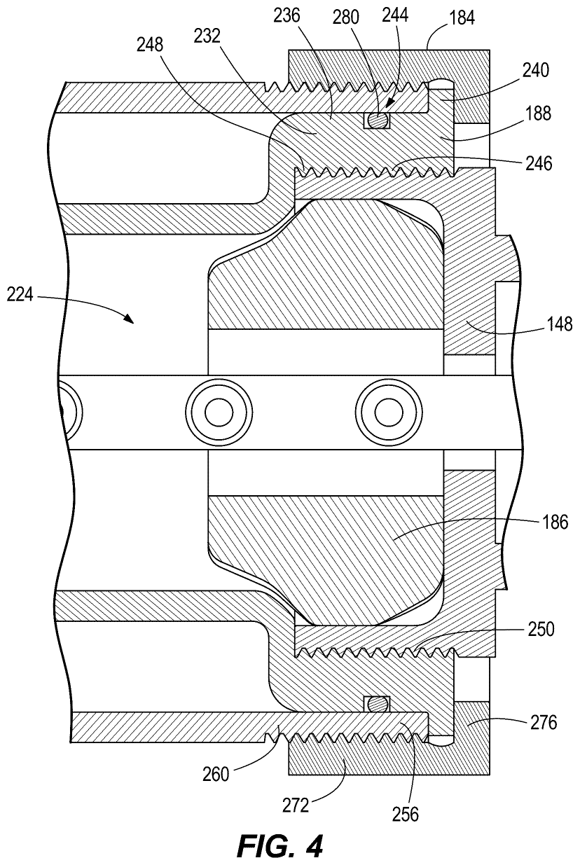

With reference to FIGS. 3-4, the drive cylinder 176 extends along a longitudinal axis 220 and includes a bore 224 extending from the first end 188 to the second end 228. A flare portion 232 is defined at the first end 188 and has an inner diameter that is greater than the inner diameter at the second end 228 of the drive cylinder 176. The flare portion 232 of the drive cylinder 176 has an outer surface 236 from which an annular flange 240 extends radially outwardly. A circumferential groove 244 extends inwardly from the outer surface 236. At least a portion of the inner surface 246 of the flare portion 232 of the drive cylinder 176 includes internal threads 248. The master supply cylinder 180 has a substantially cylindrical body 252 having an open first end 256 that has external threads 260 extending partially along the body 252 and a closed second end 264 having an inlet hole 268. The fill valve assembly 208 is coupled to the closed second end 264 of the master supply cylinder 180 and in communication with the inlet hole 268. The end cap 184 includes an internally threaded ring 272 from which an annular flange 276 extends radially inward.

With reference to FIG. 4, the bumper 186 is supported in the lifter housing 148, which is threaded to the drive cylinder 176 by engagement of the internal threads 248 and external threads 250 of the drive cylinder 176 and the lifter housing 148, respectively. The bumper 186 is at least partially supported in the lifter housing 148 such that the flare portion 232 of the drive cylinder 176 concentrically surrounds a portion of the lifter housing 148 which concentrically surrounds at least a portion of the bumper 186.

The drive cylinder 176 is positioned at least partially within the master supply cylinder 180 and the flange 240 of the drive cylinder 176 is positioned to abut the first end 256 of the master supply cylinder 180. The end cap 184 is threaded to the master supply cylinder 180 such that the flange 240 of the drive cylinder 176 is positioned between the first end 256 of the master supply cylinder 180 and the radially inwardly extending flange 276 of the end cap 184. As such, the flange 240 is clamped by the end cap 184 against the first end 256 of the master supply cylinder 180, which axially affixes the drive cylinder 176 relative to the master supply cylinder 180.

A seal 280 (e.g., an O-ring) is disposed in the groove 244 between the drive cylinder 176 and master supply cylinder 180 to reduce or substantially prevent leakage or loss of compressed gas from within the master supply cylinder 180. It will be appreciated that the seal 280 between with the drive cylinder 176 and master supply cylinder 180 and a sealing interface 284 (e.g., an O-ring) between the fill valve assembly 208 and the master supply cylinder 180 are the only interfaces with a sealing component, thus reducing the number of interfaces between the master supply cylinder 180 and the exterior of the gas spring assembly 172 at which leakage can occur.

The gas spring assembly 172 can be assembled by at least two methods. Prior to assembling, the end cap 184 is loosely placed on the lifter housing 148. In a first method, the components of the gas spring assembly 172 can be assembled sequentially. Stated another way, in a first step, the bumper 186 is positioned in the lifter housing 148. The end cap 184 may instead be placed onto the lifter housing 148 after the bumper 186 is positioned in the lifter housing 148. In a second step, the drive cylinder 176 (with the attached seal 280) are threaded to the lifter housing 148 by engaging the internal threads 248 and external threads 250 of the drive cylinder 176 and the lifter housing 148, respectively. In a third step, the drive blade 192 and piston 196 are inserted into the drive cylinder 176 as a pre-assembled unit. In a fourth step, the master supply cylinder 180 is positioned to surround the drive cylinder 176, and the first end 256 of the master supply cylinder 180 is positioned to abut the flange 240 of the drive cylinder 176. In a fifth step, the end cap 184 is threaded to the master supply cylinder 180 by engaging the internally threaded ring 272 of the end cap 184 with the external threads 260 of the master supply cylinder 180. The ring 272 is threaded upon the external threads 260 of the master supply cylinder 180 until a sufficient clamping force is developed between the first end 256 of the master supply cylinder 180 and the flange 276 of the end cap 184 to axially affix the drive cylinder 176 relative to the master supply cylinder 180. In a sixth step, the fill valve assembly 208 is coupled to the master supply cylinder 180. In another method, the fill valve assembly 208 may be preassembled with the master supply cylinder 180 and coupled to the drive cylinder 176 with the master supply cylinder 180 in the fourth step. Compressed gas can then be introduced into the master supply cylinder 180 through the fill valve assembly 208.

In another method of assembly, the gas spring assembly 172 can be assembled as a sub-assembly and then coupled to the lifter housing 148. In a first step, the master supply cylinder 180 is positioned to surround the drive cylinder 176 (with the attached seal 280), and the flange 240 abutting the first end 256 of the master supply cylinder 180. In a second step, the end cap 184 is threaded to the master supply cylinder 180 by engaging the internally threaded ring 272 of the end cap 184 with the external threads 260 of the master supply cylinder 180. The ring 272 is threaded upon the external threads 260 of the master supply cylinder 180 until a sufficient clamping force is developed between the first end 256 of the master supply cylinder 180 and the flange 276 of the end cap 184 to axially affix the drive cylinder 176 relative to the master supply cylinder 180 with the flange 240 of the drive cylinder 176 positioned between the first end 256 of the master supply cylinder 180 and the flange 276 of the end cap 184. In a third step the fill valve assembly 208 is coupled to the master supply cylinder 180. In an alternative method, the fill valve assembly 208 can be preassembled with the master supply cylinder 180 prior to beginning the first step. In a fourth step, the assembled gas-spring assembly 172 is threadedly coupled to the lifter housing 148, to which the bumper 186 has been coupled and the into which the piston 196 and drive blade 192 have already been assembled. The piston 196 is inserted into the drive cylinder 176. The drive cylinder 176 is coupled to the lifter housing 148 by engagement of the internal threads 248 of the drive cylinder and external threads 250 of the lifter housing 148. Compressed gas can then be introduced into the master supply cylinder 180 through the fill valve assembly 208.

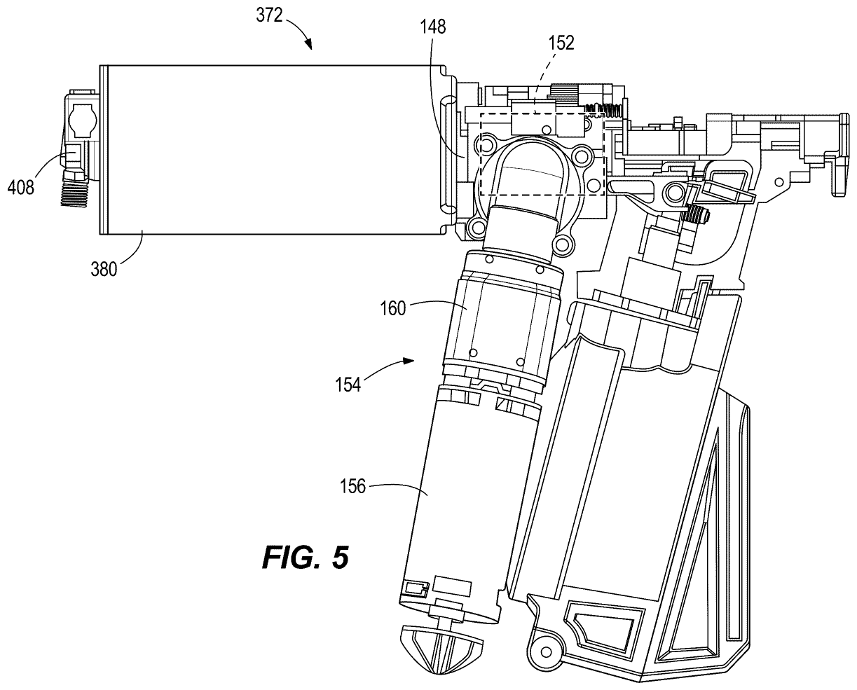

FIGS. 5-10 illustrate a second embodiment of a gas spring assembly 372, with like components and features as the embodiment of the gas spring assembly 172 shown in FIGS. 2-4 being labeled with like reference numerals plus “200.”

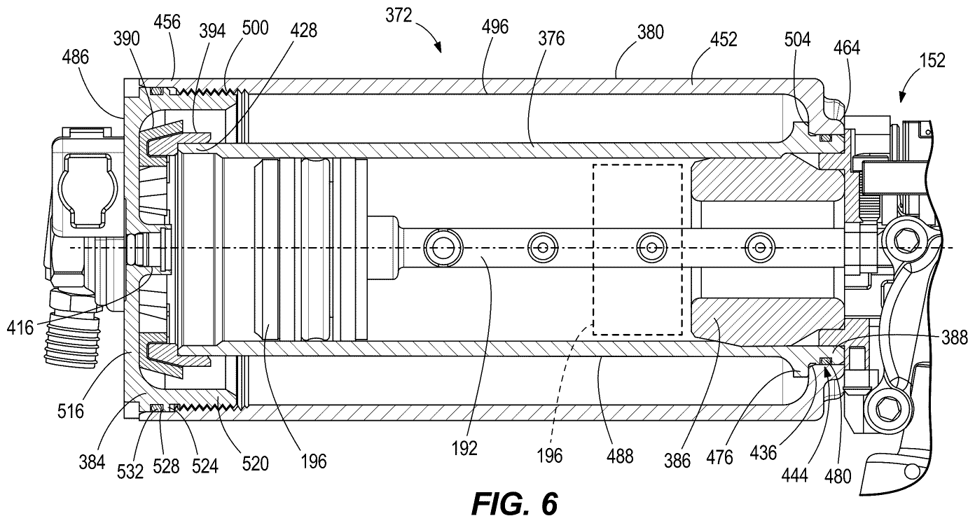

The gas spring assembly 372 includes a drive cylinder 376, a master supply cylinder 380 in which the drive cylinder 376 is at least partially positioned, and an end cap 384 coupled to the master supply cylinder 380 that axially secures the drive cylinder 376 in the master supply cylinder 380. The gas spring assembly 372 also includes a bumper 386 supported at a first end 388 of the drive cylinder 376 and a drive blade 192 and piston 196 that is reciprocally slidable within the drive cylinder 376 between a top-dead-center (TDC) position (FIG. 6) and a bottom-dead-center (BDC) position (illustrated schematically in FIG. 6) adjacent the bumper 386. The drive blade 192 and piston 196 are unitized (e.g., by a pin, press-fit arrangement, etc.) to move together between the TCD and BDC positions. The rotary lifter 152 translates the drive blade 192 and the piston 196 to the TDC position, thereby compressing the gas stored in the master supply cylinder 380. When the trigger 124 is depressed to drive a fastener into a workpiece, the compressed gas in the master supply cylinder 380, which has been compressed to a higher pressure by translation of the piston 196 to the TDC position, is permitted to expand and drive the piston 196 and the drive blade 192 toward the BDC position to discharge a fastener from the nosepiece 132. First and second support rings 390, 394 are positioned in the master supply cylinder 380 between the drive cylinder 376 and the end cap 384.

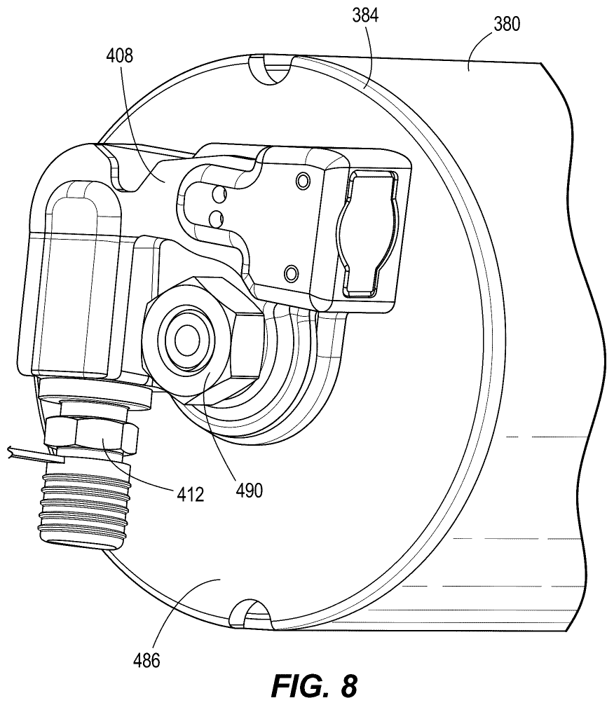

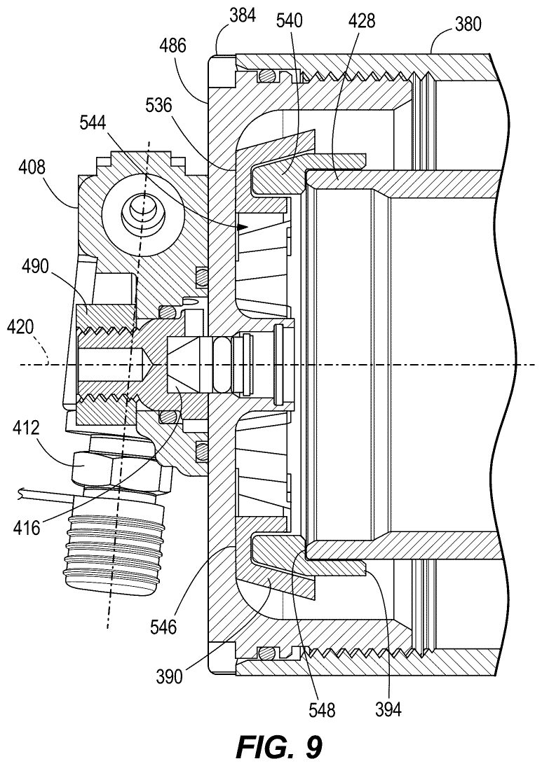

With reference to FIGS. 8-9, a fill valve assembly 408 is coupled to the end cap 384. The fill valve assembly 408 may be configured as a Schrader valve, a Presta valve, a Dunlop valve, or some other similar valve. When a source of compressed gas is coupled to the inlet fitting 412 of the fill valve assembly 408, the fill valve assembly 408 enables the master supply cylinder 380 to be filled with compressed gas or refilled with compressed gas if any leakage occurs. The inlet fitting 412 of the fill valve assembly 408 may be positioned at an angle relative to the outer surface 486 of the end cap 384 (e.g., an angle between zero degrees and ninety degrees, such as ten degrees). The fill valve assembly 408 is coupled to the end cap 384 by a positioning nut 490 that allows rotational orientation of the inlet fitting 412 (e.g., by loosening the positioning nut 490). Compressed air is introduced into the master supply cylinder 380 through the inlet fitting 412 of the fill valve assembly 408 and the inlet 416 in the end cap 384 that is in communication with the master supply cylinder 380.

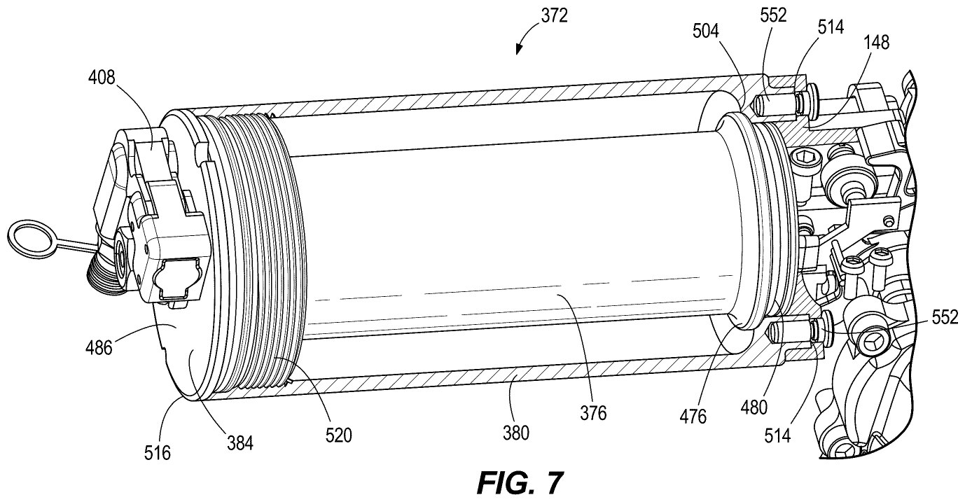

Returning with reference to FIGS. 6-7, the drive cylinder 376 extends along a longitudinal axis 420 and has a substantially cylindrical body 488 extending from an open first end 388 to an open second end 428. The first end 388 has an outer surface 436 about which a circumferential groove 444 extends and in which a seal 480 is disposed. A flange 476 extends radially outwardly from the outer surface 436.

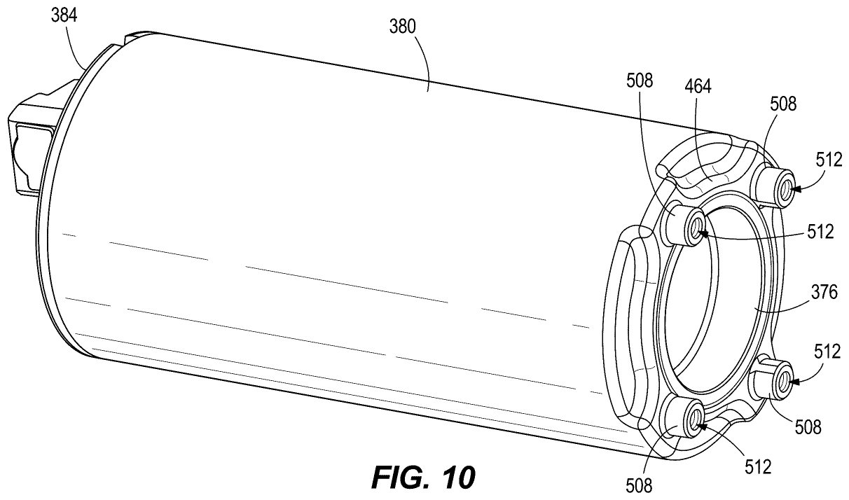

The master supply cylinder 380 has a substantially cylindrical body 452 having a bore 496 extending from an open first end 456 to an open second end 464. The first end 456 includes internal threading 500 extending at least partially along the bore 496. The bore 496 defines an inner shoulder 504 extending radially inwardly at the second end 464 of the master supply cylinder 380. With reference to FIG. 10, one or more bosses 508 (e.g., four bosses) extend from the second end 464 along the longitudinal axis 420 of the master supply cylinder 380. Each boss 508 has an internally threaded hole 512. Returning with reference to FIGS. 6-7, the bosses 508 are received in holes 514 of the lifter housing 148. The bosses 508 are positioned and sized to be within the outer circumference of the substantially cylindrical body 452 of the end cap 384 to reduce the diameter of the master supply cylinder 380.

The end cap 384 has a substantially circular base plate 516 with an outer surface 486 and an externally threaded annular ring 520 extending from the base plate 516. The base plate 516 has an inlet 416 which communicates the fill valve assembly 408 and the interior of the master supply cylinder 380. The annular ring 520 includes an outer surface 524 having a circumferential groove 528. A seal 532 is positioned in the groove 528. Other seals may be positioned between the fill valve assembly 408 and the master supply cylinder 380.

With reference to FIG. 9, each of the first and second support rings 390, 394 has a plurality of ridges 536, 540 and passageways 544 defined between the ridges 536. The ridges 540 of the second support ring 394 are nested within the ridges 536 of the first support ring 390. The ridges 536 of the first support ring 390 abut the inner surface 546 of the end cap 384. The second support ring 394 includes a shelf 548 that engages the second end 428 of drive cylinder 376 and the second support ring 394 extends from the shelf 548 at least partially along the exterior of the drive cylinder 376.

With reference to FIGS. 6-7, as assembled, the drive cylinder 376 is positioned at least partially within the master supply cylinder 380 and the flange 476 of the drive cylinder 376 is positioned to abut the inner shoulder 504 of the master supply cylinder 380. The end cap 384 is threaded to the first end 456 of the master supply cylinder 380 opposite the inner shoulder 504 and the end cap 384 applies a clamping force (via the first and second support rings 390, 394) to the flange 476 against the inner shoulder 504 to axially affix the drive cylinder 376 relative to the master supply cylinder 380.

With reference to FIGS. 6-7, the gas spring assembly 372 can be assembled in one or more methods. In a first method, the components can be assembled sequentially, that is, one component assembled at a time. In a first step, the bumper 386 is positioned in the lifter housing 148 and the drive blade 192 to which the piston 196 is coupled is inserted through the bumper 386 into the lifter housing 148. In the second step, the master supply cylinder 380 is coupled to the lifter housing 148. The bosses 508 of the master supply cylinder 380 are inserted into the holes 514 of the lifter housing 148 and fasteners 552 are threaded into the threaded holes 512 of the bosses and tightened. In the third step, the drive cylinder 376 (with the attached seal 480) are inserted into the master supply cylinder 380 through the first end 456 of the master supply cylinder 380 with the flange 476 engaging or abutting the inner shoulder 504 of the master supply cylinder 380. As the drive cylinder 376 is inserted, the piston 196 is slidably positioned in the drive cylinder 376. The flange 476 thereby positions the drive cylinder 376 relative to the master supply cylinder 380. In another embodiment of the assembly method, the drive blade 192 and piston 196 can instead be inserted into the drive cylinder 376 and lifter housing 148 following insertion of the drive cylinder 376 into the master supply cylinder 380. In the fourth step, the first and second support rings 390, 394 are positioned on the second end 428 of the drive cylinder 376. In the fifth step, the end cap 384 (and the attached seal 532) is threaded into the first end 456 of the master supply cylinder 380, with the externally threaded annular ring 520 of the end cap 384 engaging the internal threading 500 at the first end 456 of the master supply cylinder 380. The end cap 384 is tightened (e.g., with a spanner wrench engaging cutouts in the end cap 384). In a sixth step, the fill valve assembly 408 is coupled to the end cap 384 and the position of the inlet fitting 412 of the fill valve assembly 408 may be rotationally positioned. The fill valve assembly 408 may instead be coupled to the end cap 384 prior to coupling the end cap 384 to the master supply cylinder 380.

In a second method, the drive cylinder 376 and master supply cylinder 380 can be pre-assembled prior to assembly of other components of the gas spring assembly 372. In a first step, the drive cylinder 376 and attached seal 480 are inserted into the master supply cylinder 380 through the first end 456 of the master supply cylinder 380 and the flange 476 is positioned to abut the inner shoulder 504 of the master supply cylinder 380. In the second step, the master supply cylinder 380 and drive cylinder 376 subassembly can be coupled to the lifter housing 148 by fasteners 552 threaded into the holes 514 of the bosses 508 of the master supply cylinder 380. In a third step, the drive blade 192 and piston 196 are inserted into the drive cylinder 376. In a fourth step, the end cap 384 is coupled to the master supply cylinder 380, with the externally threaded annular ring 520 engaging the internal threading 500 of the master supply cylinder 380. In a fifth step, the fill valve assembly 408 is coupled to the end cap 384 and positioned via the positioning nut 490. In another embodiment, the fill valve assembly 408 may be preassembled with the end cap 384.

In a third embodiment of an assembly method, the gas spring assembly 372 (e.g., the drive cylinder 376, master supply cylinder 380, drive blade 192, piston 196, end cap 384, first and second support rings 390, and fill valve assembly 408, seals 480, 532) can be assembled as described in the previous assembly methods of the gas spring assembly 372 as one sub-assembly, and then coupled to the lifter housing 148 by inserting the bosses 508 into the holes 514 of the lifter housing 148 and inserting fasteners 552 into the internally threaded holes 512 of the bosses 508.

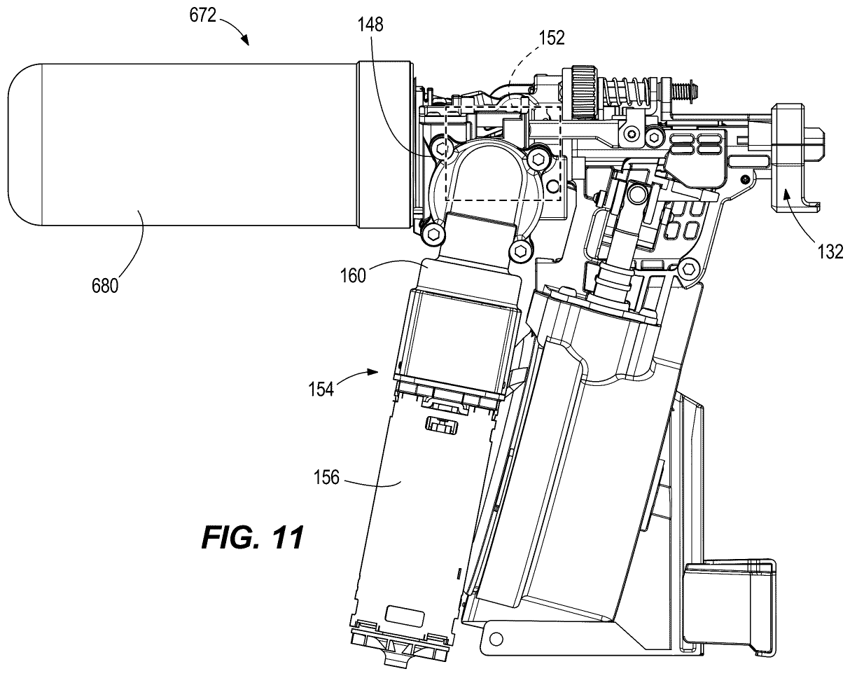

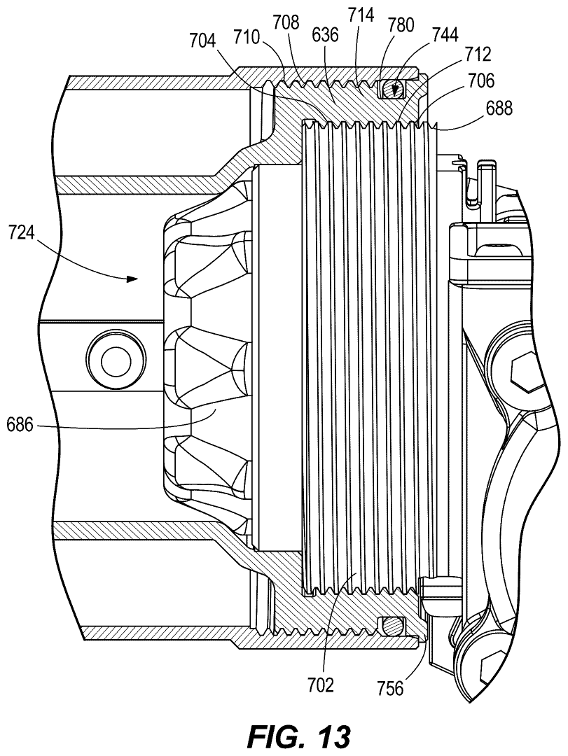

FIGS. 11-13 illustrate a third embodiment of a gas spring assembly 672, with like components and features as the embodiment of the gas spring assembly 172 shown in FIGS. 2-4 being labeled with like reference numerals plus “500.”

The gas spring assembly 672 includes a drive cylinder 676, a master supply cylinder 680 in which the drive cylinder 676 is at least partially positioned, and a bumper 686. The master supply cylinder 680 surrounds the drive cylinder 676. The drive cylinder 676 is supported by a cylinder mount 702 which is part of the lifter housing 148. The cylinder mount 702 includes external threads 706 for mounting the drive cylinder 676.

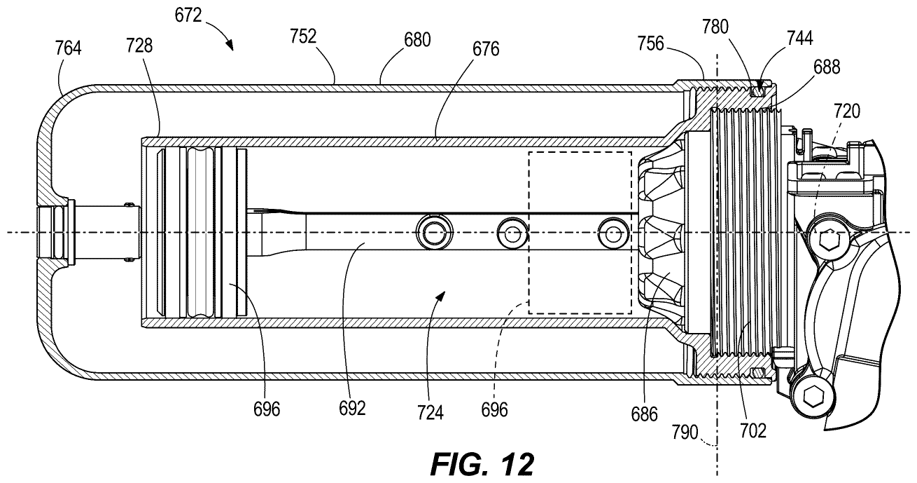

The bumper 686 is supported at a first end 688 of the drive cylinder 676. A drive blade 692 and an attached piston 696 are reciprocally slidable within the drive cylinder 676 between a top-dead-center (TDC) position (FIG. 12) and a bottom-dead-center (BDC) position (illustrated in broken lines in FIG. 12) adjacent the bumper 686. The drive blade 692 and piston 696 are unitized (e.g., by a pin, press-fit arrangement, etc.) to move together between the TDC and BDC positions. The rotary lifter 152 translates the drive blade 692 and the piston 696 from the BDC position toward the TDC position, thereby compressing compressed gas stored in the master supply cylinder 680. When the trigger 124 is depressed to drive a fastener into a workpiece, the rotary lifter 152 disengages the drive blade 692, permitting the compressed gas in the master supply cylinder 680 to expand and drive the piston 696 and the drive blade 692 toward the BDC position to discharge a fastener from the nosepiece 132.

The drive cylinder 676 extends along a longitudinal axis 720 and includes a bore 724 extending from the first end 688 to an opposite second end 728. The first end 688 of the drive cylinder 676 has internal threads 704 positioned on an inner surface 712 of the drive cylinder 676. The first end 688 of the drive cylinder 676 also has external threads 710 positioned on an outer surface 714 of the drive cylinder 676. The internal threads 704 and the external threads 710 of the drive cylinder 676 each extend partially along the length of the drive cylinder 676 and overlap each other. A reference plane 790 extends perpendicular to the longitudinal axis 720 of the drive cylinder 676. The reference plane 790 passes through the internal threads 704 and the external threads 710 on the drive cylinder 676. A circumferential groove 744 extends inwardly from an outer surface 636 of the drive cylinder 676 and is located adjacent the external threads 710. The master supply cylinder 680 has a substantially cylindrical body 752 having an open first end 756 with internal threads 708 extending partially along the length of the cylindrical body 752 and a closed second end 764. Accordingly, the drive cylinder 676 is threaded to the cylinder mount 702 via engaged internal threads 704 on the drive cylinder 676 and external threads 706 on the cylinder mount 702. And, the master supply cylinder 680 is threaded to the drive cylinder 676 via engaged internal threads 708 on the master supply cylinder 680 and external threads 710 on the drive cylinder 676. A seal 780 (e.g., an O-ring) is disposed in the groove 744 between the drive cylinder 676 and master supply cylinder 680 to reduce or substantially prevent compressed gas within the master supply cylinder 680 from leaking between the mated threads 708, 710.

Although the invention has been described in detail with reference to certain preferred embodiments, variations and modifications exist within the scope and spirit of one or more independent aspects of the invention as described.

Various features of the invention are set forth in the following claims.

1. A powered fastener driver comprising:
a drive blade movable from a top-dead-center (TDC) position to a driven or bottom-dead-center (BDC) position for driving a fastener into a workpiece;
a piston coupled to the drive blade for movement therewith between the TDC position and the BDC position;
a drive unit for providing torque to move the drive blade from the BDC position toward the TDC position;
a rotary lifter engageable with the drive blade, the rotary lifter configured to receive torque from the drive unit in a first rotational direction for returning the drive blade from the BDC position toward the TDC position; and
a gas spring assembly including
a master supply cylinder in which gas is stored and compressed by the piston in response to the piston being moved from the BDC position toward the TDC position,
a drive cylinder at least partially positioned within the master supply cylinder and having a flange against which an end of the master supply cylinder is abutted, and
an end cap secured to the master supply cylinder to apply a clamping force to the flange against the end of the master supply cylinder, thereby axially affixing the drive cylinder to the master supply cylinder.

2. The powered fastener driver of claim 1, further comprising a fill valve coupled to the master supply cylinder.

3. The powered fastener driver of claim 1, wherein the flange extends from a first end of the drive cylinder.

4. The powered fastener driver of claim 3, wherein the drive cylinder includes an outer surface from which the flange extends, the outer surface having a circumferential groove in which a seal is disposed, the seal engaging the master supply cylinder.

5. The powered fastener driver of claim 3, wherein the end cap is threadedly coupled to the master supply cylinder and the flange is positioned between the master supply cylinder and a flange of the end cap, and wherein the clamping force is applied to the flange of the drive cylinder by the flange of the end cap in response to the end cap being threaded to the master supply cylinder.

6. The powered fastener driver of claim 3, wherein the master supply cylinder includes external threads to which the end cap is threaded.

7. The powered fastener driver of claim 1, further comprising a lifter housing rotatably supporting the rotary lifter, and wherein the drive cylinder is coupled to the lifter housing.

8. The powered fastener driver of claim 7, wherein the drive cylinder includes a flare portion having internal threads, and wherein the lifter housing has external threads to which the internal threads on the flare portion are engaged.

9. A powered fastener driver comprising:
a drive blade movable from a top-dead-center (TDC) position to a driven or bottom-dead-center (BDC) position for driving a fastener into a workpiece;
a piston coupled to the drive blade for movement therewith between the TDC position and the BDC position;
a drive unit for providing torque to move the drive blade from the BDC position toward the TDC position;
a rotary lifter engageable with the drive blade, the rotary lifter configured to receive torque from the drive unit in a first rotational direction for returning the drive blade from the BDC position toward the TDC position; and
a gas spring assembly including
a master supply cylinder in which gas is stored and compressed by the piston in response to the piston being moved from the BDC position toward the TDC position,
a drive cylinder at least partially positioned within the master supply cylinder and having a flange against which an inner shoulder of the master supply cylinder is abutted, and
an end cap secured to an end of the master supply cylinder opposite the inner shoulder to apply a clamping force to the flange against the inner shoulder, thereby axially affixing the drive cylinder to the master supply cylinder.

10. The powered fastener driver of claim 9 further comprising a seal disposed between the drive cylinder and the master supply cylinder.

11. The powered fastener driver of claim 9, wherein the master supply cylinder includes a bore at least partially defined by an inner shoulder at a first end, and the end cap is coupled to a second end of the master supply cylinder opposite the inner shoulder.

12. The powered fastener driver of claim 9, further comprising a first support ring and a second support ring disposed between the end cap and a second end of the drive cylinder, the first support ring engaging the end cap and the second support ring engaging the first support ring and the drive cylinder.

13. The powered fastener driver of claim 12, wherein the clamping force is transmitted through the first support ring and the second support ring.

14. The powered fastener driver of claim 12, wherein the first support ring includes a plurality of ridges that abut the end cap and passageways between the ridges.

15. The powered fastener driver of claim 12, wherein the second support ring extends at least partially along the drive cylinder.

16. The powered fastener driver of claim 9, further comprising a lifter housing rotatably supporting the rotary lifter, wherein the lifter housing includes a plurality of holes, wherein the master supply cylinder includes a plurality of bosses having internal threads and extending from the first end, wherein the bosses are received in the corresponding holes of the lifter housing, and wherein the master supply cylinder is secured to the lifter housing by fasteners.

17. The powered fastener driver of claim 16, wherein the master supply cylinder includes four bosses.

18. The powered fastener driver of claim 9 further comprising a seal disposed between the end cap and the master supply cylinder.

19. The powered fastener driver of claim 9 further comprising a fill valve coupled to the end cap.

20. A powered fastener driver comprising:
a drive blade movable from a top-dead-center (TDC) position to a driven or bottom-dead-center (BDC) position for driving a fastener into a workpiece;
a piston coupled to the drive blade for movement therewith between the TDC position and the BDC position;
a drive unit for providing torque to move the drive blade from the BDC position toward the TDC position;
a rotary lifter supported in a lifter housing, the rotary lifter engageable with the drive blade and configured to receive torque from the drive unit in a first rotational direction for returning the drive blade from the BDC position toward the TDC position; and
a gas spring assembly including
a master supply cylinder in which gas is stored and compressed by the piston in response to the piston being moved from the BDC position toward the TDC position, the master supply cylinder having an inner shoulder and bosses that are fastened to the lifter housing,
a drive cylinder having an outer surface and a flange extending from the outer surface proximate a first end of the drive cylinder, the drive cylinder at least partially positioned within the master supply cylinder with the flange abutted against the inner shoulder of the master supply cylinder, and
an end cap threaded to an end of the master supply cylinder opposite the inner shoulder to apply a clamping force to an opposite, second end of the drive cylinder to abut the flange against the inner shoulder, thereby axially affixing the drive cylinder to the master supply cylinder.

21.-25. (canceled)
